(19) United States
(12) Patent Application Publication
(10) Pub. No.: US 2018/0271315 A1
(43) Pub. Date: Sep. 27, 2018

(54) DEVICE FOR SQUEEZING LEMONS AND LIMES AND METHODS OF USING THE SAME

(71) Applicants: Sidney Lebaron, El Paso, TX (US); Garlan Lebaron, Helotes, TX (US); Gregory Lebaron, Williston, ND (US); Seth Lebaron, Galeana (MX)

(72) Inventors: Sidney Lebaron, El Paso, TX (US); Garlan Lebaron, Helotes, TX (US); Gregory Lebaron, Williston, ND (US); Seth Lebaron, Galeana (MX)

(21) Appl. No.: 15/466,862

(22) Filed: Mar. 22, 2017

(51) Int. Cl. A47J 19/02

(52) U.S. Cl. CPC A47J 19/022

(57) ABSTRACT

A device for squeezing lemon and limes and a method of using the same are disclosed herein. It is an object of the invention to squeeze lemon and limes in a more efficient and effective manner by not having to prep the lemon or lime for squeezing and wherein the fluids or juice extracted from the lemon or lime is channeled through the device and out through exit ports for easy extraction. In embodiments, the device for squeezing lemon and limes generally is comprised of a holding body component and a pressing body component. In embodiments, the holding body component is comprised of a handle portion and a lemon or lime support portion. In embodiments, the pressing body component is comprised of a handle portion and a pressing portion.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention relates generally to a device and method of use for squeezing lemons and limes. More specifically, the present invention relates to a device and method of use for squeezing lemons and limes without having to prep the lemon or lime for squeezing and wherein the fluids extracted from the lemon or lime is channeled through the device.

### BACKGROUND OF THE INVENTION

Without limiting the scope of the disclosed device and method, the background is described in connection with a novel device and approach to squeezing lemons and limes.

The field's prior art fails to provide an effective and efficient way to squeeze lemon and limes. Current state of the art lemon and lime squeezers require an individual to prep or cut the lemon or lime in at least halves before placing into the lemon and lime squeezer. This additional step takes time and requires the individual to use and contaminate a cutting utensil such as a knife. In addition to needing an additional cutting utensil, a mess is usually made from cutting up the lemons and limes. A cutting board may also be used in the cutting process further contaminating another item, which will also require cleaning. A second drawback to current state of the art lemon and lime squeezers is that when they are used, often times the fruit's fluids or juice shoots or is pressured out the side and top openings of the squeezer causing the individual using the squeezer to get sprayed with the juices as well as the surrounding environment. This is due to the fact that the fluids or juice of the lemon or lime cannot exit the device quick enough or is blocked from exiting by the squeezing process therefore causing the fluids or juice to be pressured back out the sides and top openings of the device.

In view of the foregoing, it is apparent that there exists a need in the art for a lemon and lime squeezer, which overcomes, mitigates, or solves the above problems in the art. It is the purpose of this invention to fulfill this and other needs in the art, which will become apparent to the skilled artisan once given the following disclosure.

### BRIEF SUMMARY OF THE INVENTION

The present invention, therefore, provides for a device and method of use for squeezing lemons and limes in a more efficient and effective manner.

In an embodiment, the device for squeezing lemon and limes generally is comprised of a holding body component and a pressing body component. In embodiments, the holding body component is comprised of a handle portion and a lemon or lime support portion. In embodiments, the pressing body component is comprised of a handle portion and a pressing portion. In embodiments, the holding body component's lemon or lime support portion is further configured with fluid flow channels, at least one fluid exit port, and at least one cutting portion along the internal cavity or cup portion of said support portion. In a further embodiment, the holding body component's lemon or lime support portion is further configured with pressing ridge portions along the internal cavity or cup portion of said support portion.

In embodiments, the pressing body component is further configured with cutting portion receiving cavities and pressing ridge portion receiving cavities.

In another embodiment, the device for squeezing lemon and limes is further comprised with six exit ports, two cutting portions, and a pressing ridge portion all located within the internal cavity or cup portion of said holding body component's lemon or lime support portion.

In summary, the present invention discloses a device and method of use for squeezing lemons and limes. More specifically, the present invention relates to a device and method of use for squeezing lemons and limes without having to prep the lemon or lime for squeezing and wherein the fluids or juice extracted from the lemon or lime is channeled through the device for easy extraction.

### BRIEF DESCRIPTION OF THE SEVERAL VIEWS OF THE DRAWINGS

The accompanying drawings, which are incorporated in and form a part of the specification, illustrate a preferred embodiment of the present invention, and together with the description, serve to explain the principles of the invention. It is to be expressly understood that the drawings are for the purpose of illustration and description only and are not intended as a definition of the limits of the invention. In the drawings:

FIG. 1 is an open position right side perspective view of the device for squeezing lemons and limes in accordance with the teachings of the present disclosure;

FIG. 2 is a closed position right side perspective view of the device for squeezing lemons and limes in accordance with the teachings of the present disclosure;

FIG. 3 is an open position bottom view of the device for squeezing lemons and limes in accordance with the teachings of the present disclosure;

FIG. 4 is an open position top view of the device for squeezing lemons and limes in accordance with the teachings of the present disclosure;

FIG. 5 is an open position front view of the device for squeezing lemons and limes in accordance with the teachings of the present disclosure;

FIG. 6 is an open position back view of the device for squeezing lemons and limes in accordance with the teachings of the present disclosure;

FIG. 7 is an open position right side view of the device for squeezing lemons and limes in accordance with the teachings of the present disclosure;

FIG. 8 is a top half sectional view of the holding portion of the device for squeezing lemons and limes in accordance with the teachings of the present disclosure;

FIG. 9 is a left side sectional view of the holding portion of the device for squeezing lemons and limes in accordance with the teachings of the present disclosure;

FIG. 10 is an environmental view of the device for squeezing lemons and limes showing a lemon or lime being squeezed to obtain the fluids or juice from the fruit in accordance with the teachings of the present disclosure.

### DETAILED DESCRIPTION OF THE INVENTION

Disclosed herein is an improved device and method of use for squeezing lemons and limes as well as other fruit. The numerous innovative teachings of the present invention will be described with particular reference to several embodiments (by way of example, and not of limitation).

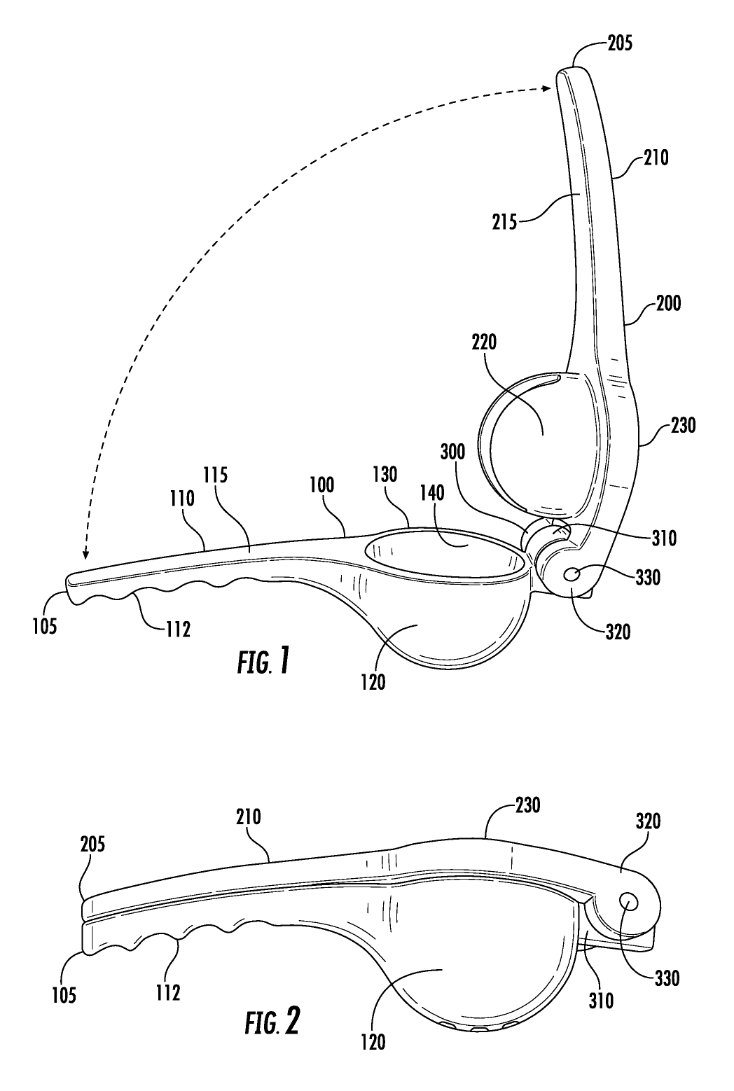

Reference is first made to FIG. 1, an open position right side perspective view of the device for squeezing lemons and limes in accordance with the teachings of the present disclosure.

In an embodiment, the device for squeezing lemon and limes generally is comprised of a holding body component 100 and a pressing body component 200. In embodiments, the holding body component 100 is comprised of a handle portion 110 and a lemon or lime support portion 120. In embodiments, the pressing body component 200 is comprised of a handle portion 210 and a pressing portion 220.

The holding body component 100 and the pressing body component 200 are integrally formed, connected, or attached and allowed to pivot in relation to each other along a horizontal plane. In an embodiment, this is accomplished through a hinge connection. The hinge connection in an embodiment is accomplished by having a left side hinge portion 300 and a right side hinge portion 320 on the pressing body component 200 as well as a middle hinge portion 310 on the holding body component 100. A rod, screw, pin, or similar structure 330 is threaded or connects the left side hinge portion 300, the right side hinge portion 320, and the middle hinge portion 310. In embodiments, the holding body component 100 and the pressing body component 200 rotate about the rod, screw, pin, or similar structure 330.

In embodiments, the holding body component's 100 handle portion 110 and the pressing body component's 200 handle portion 210 are structures which allow a user of the device to easily grab each component with their hands or fingers and open and close the device for use in squeezing or extracting the lemon and lime fluids or juice. In embodiments, the handle portions 110, 210 may have finger ridges 112 for ergonomics and ease of grasping. The ends of the handle portions 105, 205 are clearly seen in this figure.

In embodiments, the holding body component's 100 lemon or lime support portion 120 is a structure configured to hold the lemon or lime and make take the shape as an example and not a limitation of a scoop, cup, bowl, or semi-circle cavity. The lemon or lime support portion 120 has an internal surface (internal cavity or cup portion) 140, and external surface 120, and a top lip or ridge 130. The holding body component's 100 lemon or lime support portion 120 is configured to receive the pressing body component's 200 pressing portion 220.

In embodiments the pressing body component's 200 pressing portion 220 is a structure which has the function of pressing down against the lemon or lime or fruit against the holding body component's 100 lemon or lime support portion 120. The pressing body component's 200 pressing portion 220 is configured to be received by the holding body component's 100 lemon or lime support portion 120. In embodiment's, the pressing body component's 200 pressing portion 220 is shaped like a semi-circle or half ball.

This figure illustrates the device in the open position. From this position, a user may place the lemon, lime, or fruit in the holding body component's 100 lemon or lime support portion 120.

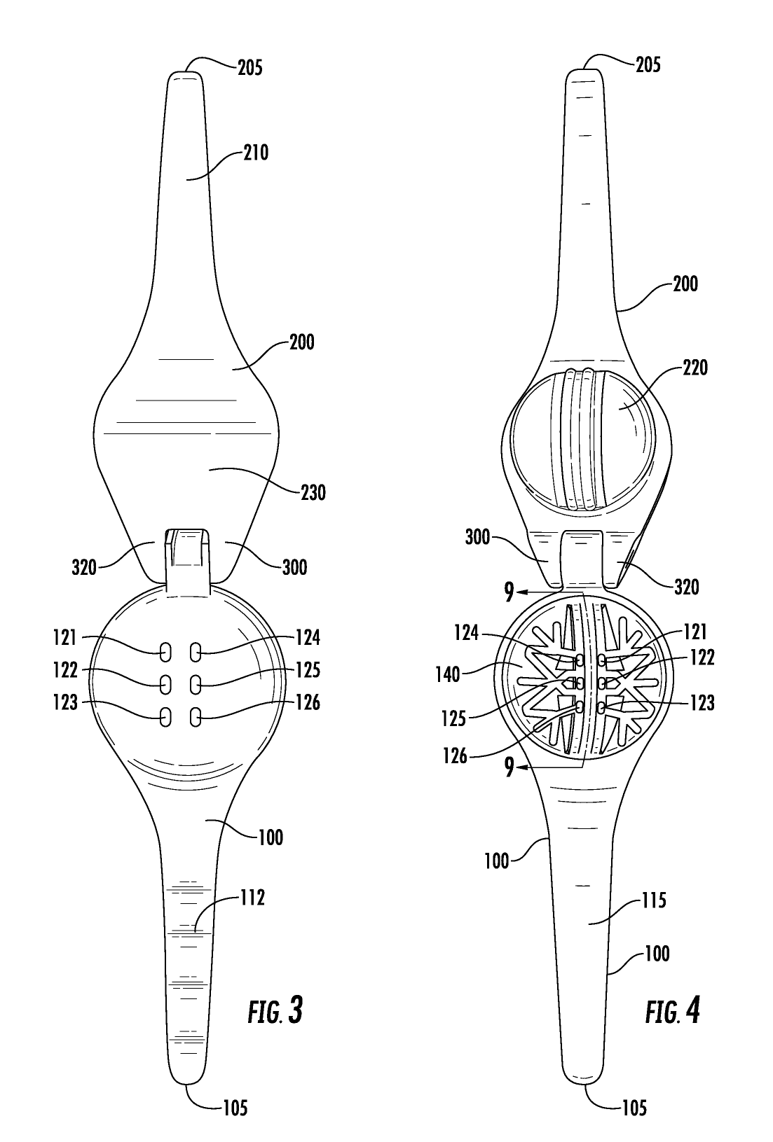

Reference is next made to FIG. 2, a closed position right side perspective view of the device for squeezing lemons and limes in accordance with the teachings of the present disclosure. Illustrated in this figure is the device in a closed position. This is the position of the device when a lemon, lime, or fruit has been squeezed.

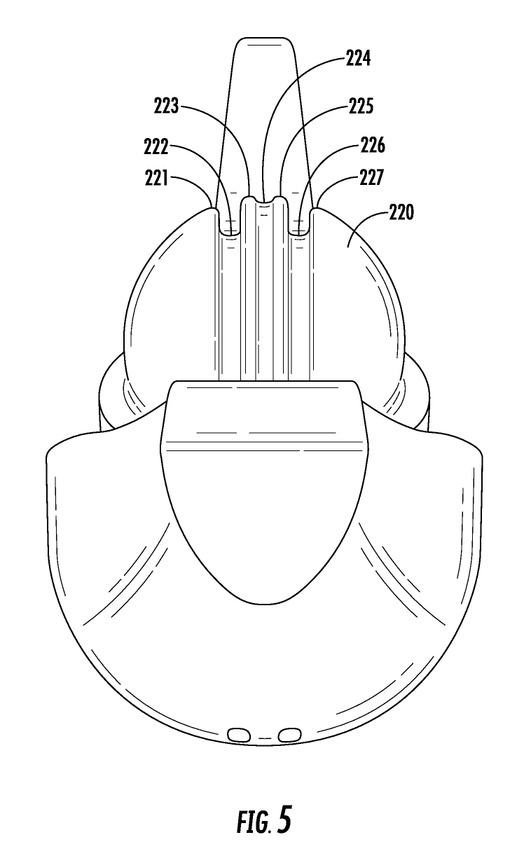

Reference is now made to FIG. 3, an open position bottom view of the device for squeezing lemons and limes in accordance with the teachings of the present disclosure. Illustrated in this figure are the fluid or juice exit ports 121, 122, 123, 124, 125, 126 as viewed from the bottom of the device. These are the ports where the fluid or juice from the squeezed lemon, lime, or fruit exit the device. Also seen in this figure are the left side hinge portion 300, the right side hinge portion 320, and the middle hinge portion 310, which make up the hinge structure.

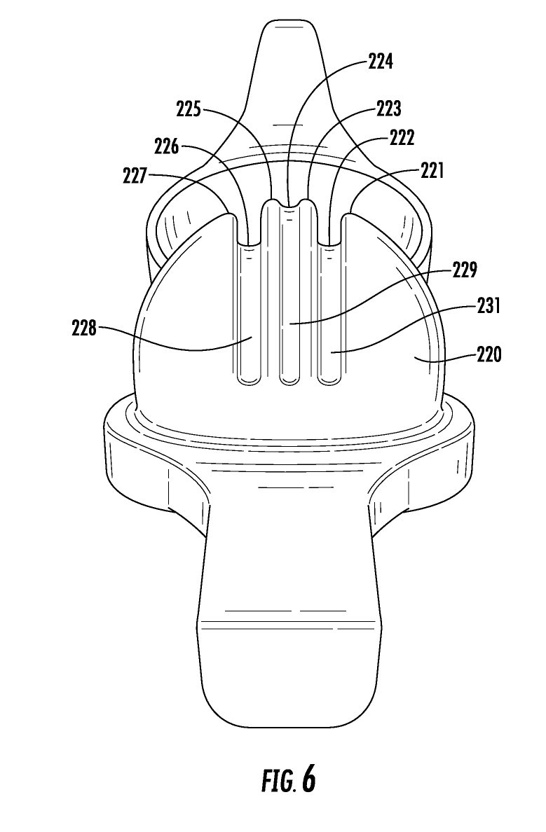

Reference is next made to FIG. 4, an open position top view of the device for squeezing lemons and limes in accordance with the teachings of the present disclosure. Illustrated in this figure is a top view of the pressing body component's 200 pressing portion 220 as well as the left side hinge portion 300, the right side hinge portion 320, and the middle hinge portion 310, which make up the hinge structure. The fluid or juice exit ports 121, 122, 123, 124, 125, 126 as viewed from the top of the device can also be seen. As a reference layout the fluid or juice exit ports will also be referenced as the left side fluid or juice exit ports 124, 125, 126 and the right side fluid or juice exit ports 121, 122, 123. In another reference layout the fluid or juice exit ports will also be referenced as the top side fluid or juice exit ports 121, 122, the middle fluid or juice exit ports 122, 125, and the bottom fluid or juice exit ports 123, 126.

Also illustrated in this figure are the fluid flow channels and the cutting portions on the inside cavity of the holding body component's 100 lemon or lime support portion 120 which will be discussed further herein. Additionally, also illustrated in this figure are the cutting portion receiving cavities and a pressing ridge receiving cavity of the pressing body component's 200 pressing portion 220

Reference is now made to FIG. 5, an open position front view of the device for squeezing lemons and limes in accordance with the teachings of the present disclosure. In embodiments, the pressing body component 220 is further configured with cutting portion receiving cavities 222, 226 and a pressing ridge portion receiving cavity 224. In embodiments, these cavities 222, 226, 224 run along a portion of the pressing body component 220 radially or an offset of a radial location or path. In embodiments these cavities 222, 226, 224 may run the entire length or a portion of the length of the pressing body component 220 radially or an offset of a radial location or path. The cutting portion receiving cavities 222, 226 and the pressing ridge portion receiving cavities 224 are configured to receive the cutting portions and the pressing ridge portions that are on the holding body component's 100 lemon or lime support portion 120. That is the cavities 222, 224, 226 provide channels for the cutting portions and the pressing ridge portions to enter into and provide more effective cutting and pressing. In an embodiment the device is comprised of a left side cutting portion receiving cavity 226 having a lip or top corners 225, 227, a middle pressing ridge portion receiving cavity 224 having a lip or top corners 223, 225, and a right side cutting portion receiving cavity 222 having a lip or top corners 221, 223. In an embodiment, the left side cutting portion receiving cavity 226 shares a lip or top corner 225 with the middle pressing ridge portion receiving cavity 224 and the right side cutting portion receiving cavity 222 shares a lip or top corner 223 with middle pressing ridge portion receiving cavity 224. In a further embodiment, the middle pressing ridge portion receiving cavity's 224 depth 224 is shallower, deeper, or equal than the left side cutting portion receiving cavity's 226 and the right side cutting portion receiving cavity's 222 depth 222, 226. In embodiments, the left side cutting portion receiving cavity's 226 and the right side cutting portion receiving cavity's 222 depth's 222, 226 are the same.

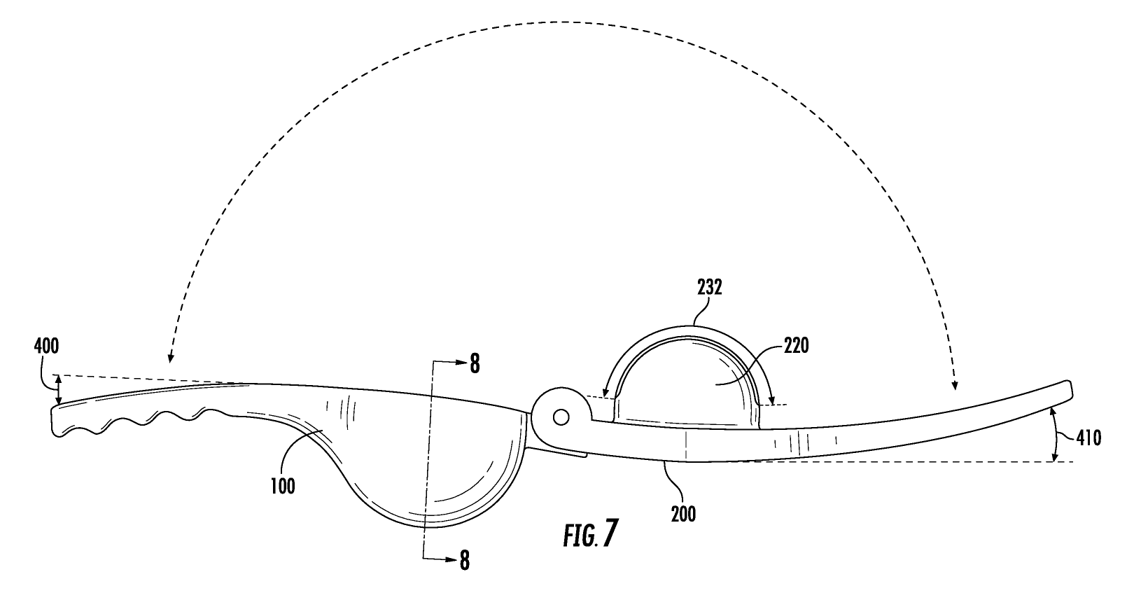

Reference is next made to FIG. 6, an open position back view of the device for squeezing lemons and limes in accordance with the teachings of the present disclosure. Illustrated in this figure is a different view of cutting portion receiving cavities 222, 226 and a pressing ridge portion receiving cavity 224. The number and type of cavities may vary to match the number and type of cutting portions and pressing ridge portions that are on the holding body component's 100 lemon or lime support portion 120. The preferred embodiment is illustrated in the figures showing the device having two cutting portion receiving cavities 222, 226 with a pressing ridge portion receiving cavity 224 between the two with the pressing ridge portion receiving cavity's 224 depth 224 being shallower than the two cutting portion receiving cavity's depth 222, 226 which are at equal depths 222, 226.

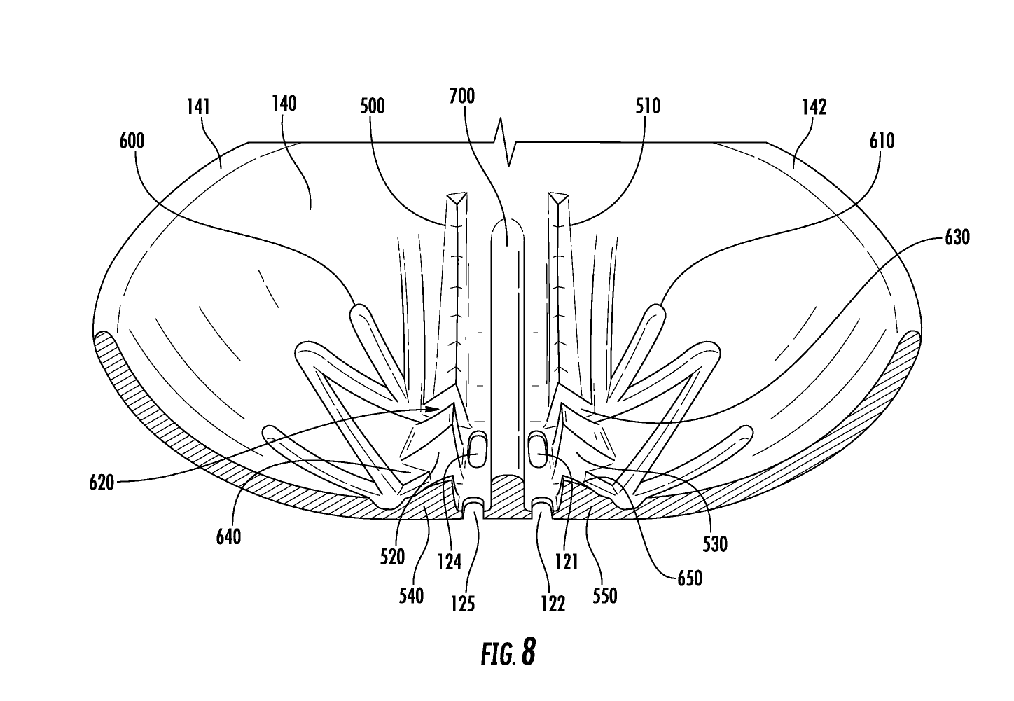

Reference is now made to FIG. 7, an open position right side view of the device for squeezing lemons and limes in accordance with the teachings of the present disclosure. Illustrated in this figure are embodiments where the handle portions 110, 210 are angled or have curvatures 400, 410 to them to aid a user of the device in the pressing of the holding body component 100 with the pressing body component 200. Also shown in this figure is the radial path or offset path 232 along the pressing body component's 200 pressing portion 220 the cutting portion receiving cavities 222, 226 and the pressing ridge portion receiving cavity 224 may run along.

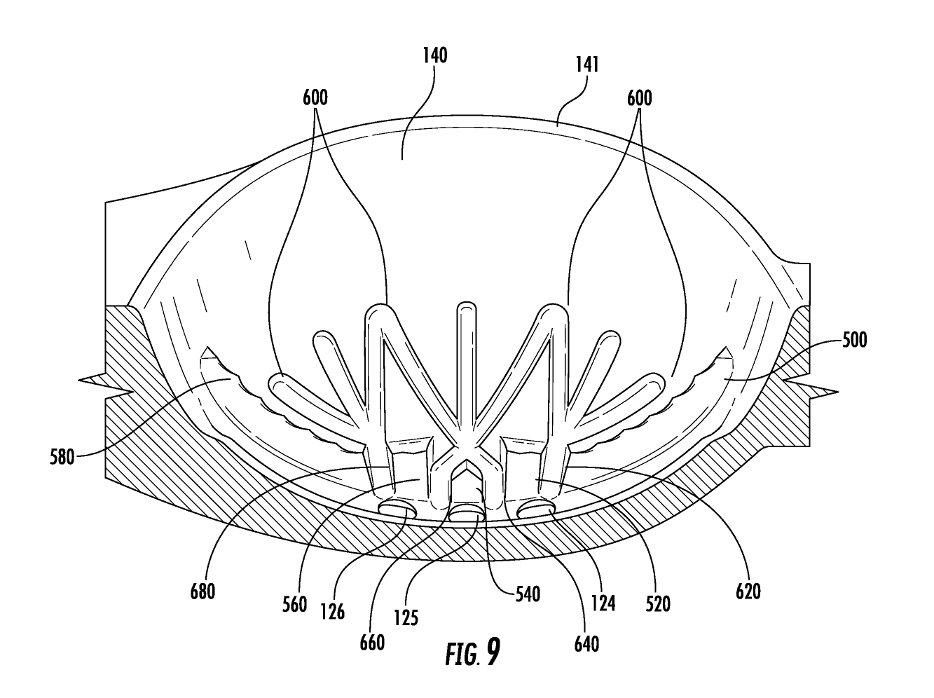

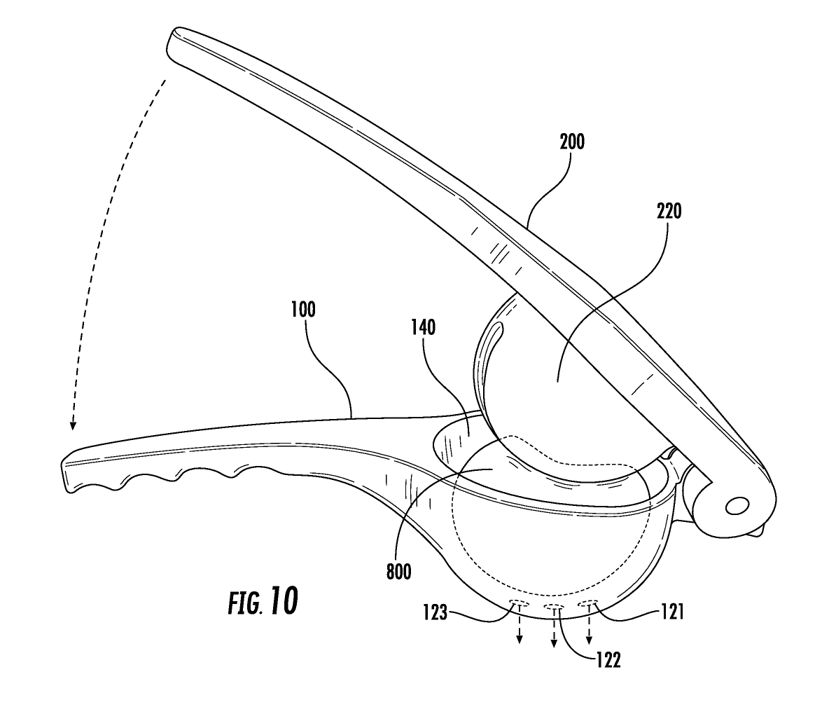

Reference is next made to FIG. 8 and FIG. 9, a top half sectional view from FIG. 7 and a left side sectional view from FIG. 4 of the holding portion of the device for squeezing lemons and limes in accordance with the teachings of the present disclosure. These two figures are cuts across the middle of the holding body component's 100 lemon or lime support portion's 120 internal surface (internal cavity or cup portion) 140. That is the other half of the lemon or lime support portion's 120 internal surface (internal cavity or cup portion) 140 is a mirror image in embodiments.

In embodiments, the holding body component's 100 lemon or lime support portion 120 is further configured with fluid flow channels 600, 610, 620, 630, 640, 650, 660, 680, at least one fluid exit port 121, 122, 123, 124, 125, 126, and at least one cutting portion 500, 510, 520, 530, 540, 550, 560, 580 along the internal cavity or cup portion 140 of said holding body component's 100 lemon or lime support portion 120. The fluid flow channels 600, 610, 620, 630, 640, 650, 660, 680 provide a pathway for the squeezed fluids or juice from the lemon or lime to flow to and out the fluid or juice exit ports 121, 122, 123, 124, 125, 126. The fluid flow channels 600, 610, 620, 630, 640, 650, 660, 680 in embodiments may be cavities or half pipe structures which outline the internal surface (internal cavity or cup portion) 140 of the holding body component's 100 lemon or lime support portion 120.

In embodiment's the device is configured with two cutting portions 500, 510, 520, 530, 540, 550, 560, 580 along the internal cavity or cup portion 140 of said holding body component's 100 lemon or lime support portion 120. The left side cutting portion 500, 520, 540, 560, 580 runs from the front 500 to the back 580 of the holding body component's 100 lemon or lime support portion's 120 internal surface (internal cavity or cup portion) 140 and is partitioned or channeled through by the fluid flow channels at flow channel locations 620, 640, 660, 680. This allows the fluid or juice from the lemon or lime to flow and reach the fluid or juice exit ports 121, 122, 123, 124, 125, 126. This design allows a pathway for the fluids or juice to exit properly through the fluid or juice exit ports 121, 122, 123, 124, 125, 126. The right side cutting portion 510, 530, 550 also runs from the front 510 to the back of the holding body component's 100 lemon or lime support portion's 120 internal surface (internal cavity or cup portion) 140 and is partitioned or channeled through by the fluid flow channels at flow channel locations some of which are captured in FIG. 8 630, 650, 660, 680. The cutting portions 500, 510, 520, 530, 540, 550, 560, 580 cut the lemon, lime, or fruit open as the device is pressed closed so that the fluids or juice may be extracted out.

In embodiments, the holding body component's 100 lemon or lime support portion 120 is further configured with pressing ridge portions 700 along the internal cavity or cup portion 140 of said holding body component's 100 lemon or lime support portion 120. In embodiments this structure is a ridge or raised portion between the left side fluid or juice exit ports 124, 125, 126 and the right side fluid or juice exit ports 121, 122, 123. This structure also helps in the fluid or juice channeling as well as in the cutting and pressing of the lemon, lime, or fruit.

Lastly, reference is made to FIG. 10, an environmental view of the device for squeezing lemons and limes showing a lemon or lime being squeezed to obtain the fluids or juice from the fruit in accordance with the teachings of the present disclosure. Illustrated in this figure is the device squeezing a lemon, lime, or fruit 800 with the fluids or juice exiting the device through the fluid or juice exit ports 121, 122, 123. The pressing body component's 200 pressing portion 220 is being received or pressed into the holding body component's 100 lemon or lime support portion 120 with the lemon, lime, or fruit 800 between the two being juiced or squeezed.

The disclosed device and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications for this invention include using this device and method of use for other fruits. Consequently, any embodiments comprising a one piece or multi piece device having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent applications are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The device and/or methods disclosed and claimed herein can be made and executed without undue experimentation in light of the present disclosure. While the device and methods of this invention have been described in terms of preferred embodiments, it will be apparent to those skilled in the art that variations may be applied to the device and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A device for squeezing lemons and limes comprising:
a holding body component;
a pressing body component;
wherein said holding body component is configured with fluid exit ports; and
wherein said holding body component is configured with fluid flow channels.

2. The device of claim 1, wherein said holding body component is further configured with a handle portion and a support portion.

3. The device of claim 2, wherein said pressing body component is further configured with a handle portion and a pressing portion.

4. The device is claim 3, wherein said holding body component handle portion and said pressing body component holding portion is configured with an angle.

5. The device of claim 3, wherein said holding body component support portion is further configured with at least one cutting portion and said pressing body component pressing portion is configured with a corresponding cutting portion receiving cavity.

6. The device of claim 3, wherein said holding body component support portion is further configured with a pressing ridge portion and said pressing body component pressing portion is configured with a corresponding pressing ridge receiving cavity.

7. The device of claim 3, wherein said holding body component support portion is further configured with at least one cutting portion and said pressing body component pressing portion is configured with a corresponding cutting portion receiving cavity; and wherein said holding body component support portion is further configured with a pressing ridge portion and said pressing body component pressing portion is configured with a corresponding pressing ridge receiving cavity.

8. The device of claim 3, wherein said holding body component and said pressing body component are joined by a hinge connection.

9. The device of claim 8, wherein said hinge connection is formed by said holding body component support portion having a middle hinge portion and said pressing body component pressing portion having a left side hinge portion and a right side hinge portion.

10. A device for squeezing lemons and limes comprising:
a holding body component;
a pressing body component;
wherein said holding body component is configured with fluid exit ports;
wherein said holding body component is configured with fluid flow channels;
wherein said holding body component is further configured with a handle portion and a support portion;
wherein said pressing body component is further configured with a handle portion and a pressing portion;
wherein said holding body component support portion is further configured with two cutting portions and said pressing body component pressing portion is configured with two corresponding cutting portion receiving cavities; and wherein said holding body component support portion is further configured with a pressing ridge portion and said pressing body component pressing portion is configured with a corresponding pressing ridge receiving cavity;
wherein said holding body component and said pressing body component are joined by a hinge connection; and
wherein said hinge connection is formed by said holding body component support portion having a middle hinge portion and said pressing body component pressing portion having a left side hinge portion and a right side hinge portion.
